(19) United States
(12) Patent Application Publication
(10) Pub. No.: US 2013/0036257 A1
(43) Pub. Date: Feb. 7, 2013

(54) MEMORY SYSTEM WHICH CAN AVOID UNAVAILABILITY DUE TO OPERATION ERROR BY USER

(71) Applicants: Takaya SUDA, Kamakura-shi (JP); Takafumi Ito, Ome-shi (JP)

(72) Inventors: Takaya SUDA, Kamakura-shi (JP); Takafumi Ito, Ome-shi (JP)

(21) Appl. No.: 13/235,436

(22) Filed: Sep. 18, 2011

(30) Foreign Application Priority Data
Aug. 1, 2011 (JP) 2011-168372

(51) Int. Cl. G06F 12/00

(52) U.S. Cl. 711/103; 711/E12.008

(57) ABSTRACT

According to one embodiment, a memory system includes a nonvolatile semiconductor storage device and controller. The nonvolatile semiconductor storage device has a file system area including a file allocation table (FAT), a data write-once area including a plurality of clusters, and a management information area which stores a pointer indicating a rewrite inhibition area of the clusters. The controller reads the FAT from the file system area of the nonvolatile semiconductor storage device, and sets the pointer based on a cluster use status recorded in the FAT.

### CROSS-REFERENCE TO RELATED APPLICATIONS

This application is based upon and claims the benefit of priority from prior Japanese Patent Application No. 2011-168372, filed Aug. 1, 2011, the entire contents of which are incorporated herein by reference.

### FIELD

Embodiments described herein relate generally to a memory system as a write-once card compatible with, for example, a write-once-type file allocation table (FAT).

### BACKGROUND

A write-once card, which allows write-once access of new data while preventing written data from being overwritten by that data, suffers an unavailability problem of the card due to an operation error by the user.

“Write-once” is a method which writes data at only a sector address after a logical sector address of previously written data, and “overwrite” is a write method of writing data at an arbitrary sector address irrespective of the logical sector address of previously written data.

### BRIEF DESCRIPTION OF THE DRAWINGS

FIG. 1 is a schematic block diagram showing a host apparatus and memory system applied to an embodiment;

FIGS. 2A and 2B are views showing the relationship between a NAND flash memory and write-once management pointer;

FIG. 3 is a flowchart showing a write operation of the host apparatus;

FIG. 4 is a flowchart showing a write operation of a memory controller;

FIG. 5 is a view showing an example of a FAT before a file is written;

FIG. 6 is a view showing an example of the FAT after a file is written;

FIG. 7 is a flowchart showing an operation at the time of initialization of a memory card; and

FIG. 8 is a view showing the operation at the time of initialization of a memory card, and showing an example of the FAT.

### DETAILED DESCRIPTION

In general, according to one embodiment, a memory system includes a nonvolatile semiconductor storage device and controller. The nonvolatile semiconductor storage device has a file system area including a file allocation table (FAT), a data write-once area including a plurality of clusters, and a management information area which stores a pointer indicating a rewrite inhibition area of the clusters. The controller reads the FAT from the file system area of the nonvolatile semiconductor storage device, and sets the pointer based on a cluster use status recorded in the FAT.

For example, a write-once card, which can prevent falsification of data, inhibits overwriting of data in an already written memory area, and allows a write-once access of new data in an area after the already written memory area. In this write-once card, a write-once accessible area is managed by a pointer.

In the write-once card, a format operation is inhibited. However, a format operation may often be executed by an operation error of the user.

On the other hand, some format programs make a write access to a final address, and when formatting is executed using such format program, a card controller sets a pointer at a final address of a card. For this reason, the entire area of the memory is set in a write-inhibited area, and subsequent write accesses can no longer be made.

This embodiment inhibits overwriting of data in an already written memory area, and allows a card to be continuously used even when a format operation is executed by an operation error of the user.

The embodiment will be described hereinafter with reference to the drawings.

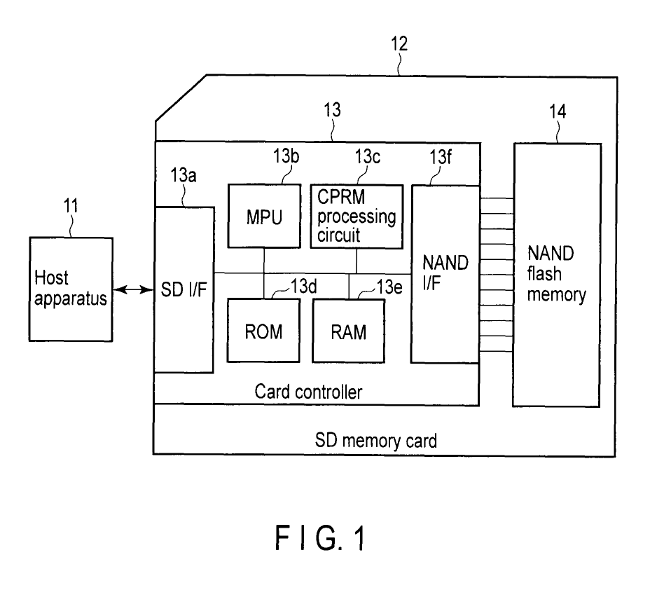

FIG. 1 schematically shows principal parts of a host apparatus and memory system to which this embodiment is applied.

A host apparatus 11 has an SD interface (not shown), and includes hardware and software required to access a memory card 12 as a memory system, which is connected to this interface. The host apparatus 11 is, for example, a digital camera, and includes software such as applications and an operating system.

When the host apparatus 11 writes data to the memory system, for example, a Secure Digital (SD) memory card (simply referred to as a memory card hereinafter) 12, it issues a write command, and transfers a write address and data to the memory card 12. When the host apparatus 11 reads data from the memory card 12, it issues a read command, and transfers a read address to the memory card 12.

The memory card 12 includes a card controller 13 and NAND flash memory 14.

The card controller 13 has an SD interface (I/F) 13a, microprocessing unit (MPU) 13b, content protection recordable media (CPRM) processing circuit 13c, read-only memory (ROM) 13d, random access memory (RAM) 13e, and NAND interface (I/F) 13f.

The SD interface 13a has hardware and software required to execute interface processing between the host apparatus 11 and card controller 13. The memory card 12 (controller 13) communicates with the host apparatus 11 via the SD interface 13a. The SD interface 13a specifies protocols that allow communications between them, and includes various command sets as in the SD interface of the host apparatus 11.

The ROM 13d stores, for example, firmware (control program) controlled by the MPU 13b. The RAM 13e is used as a work area of the MPU 13b, and stores control programs and various tables.

The MPU 13b controls the operations of the overall memory card 12. The MPU 13b reads the control program stored in the ROM 13d into the RAM 13e and executes predetermined processing in a state in which, for example, the memory card 12 receives a power supply or an initialization command from the host apparatus 11. More specifically, the MPU 13b executes predetermined processing for the NAND flash memory 14 upon reception of a write command and read command from the host apparatus 11, and controls a write-once management pointer 15 (described later). The MPU 13b manages a data storage state of the NAND flash memory 14. Management of the storage state is to manage a relationship indicating at which of logical addresses allocated by the host apparatus 11 data are saved, and which of physical address pages (or physical blocks) are in an erased state (nothing is written or invalid data is held).

The CPRM processing circuit 13c executes secure data processing.

The NAND interface 13f executes interface processing between the card controller 13 and NAND flash memory 14.

The NAND flash memory 14 is configured by a multi-valued memory that can store, for example, data of a plurality of bits in one memory cell.

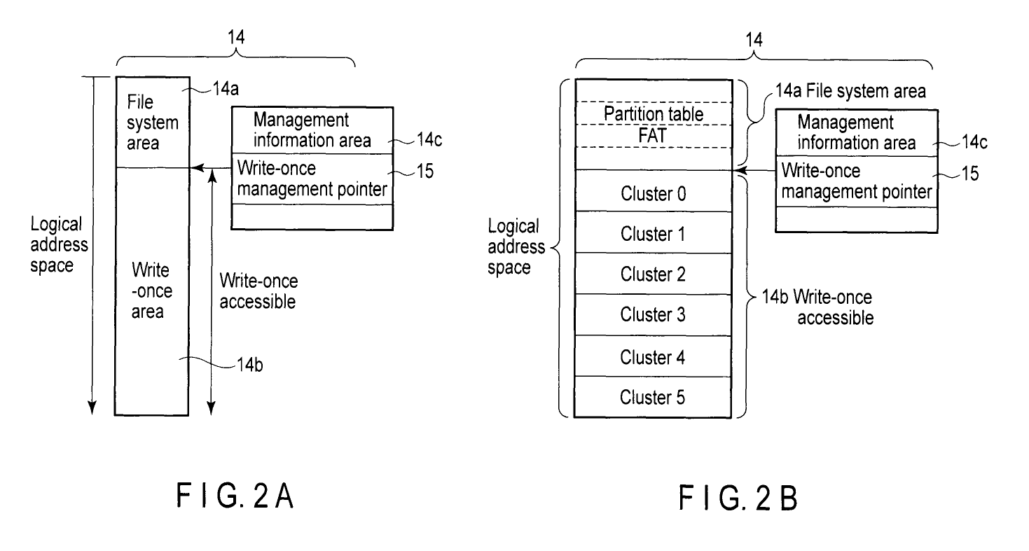

FIGS. 2A and 2B show the relationship between a logical address memory space and the write-once management pointer 15. FIG. 2B is a partially enlarged view of FIG. 2A. As described above, the MPU 13b manages correspondence between logical addresses which are received from the host apparatus 11 by the memory card 12 and physical addresses of the NAND flash memory 14, and the logical address memory space shown in FIGS. 2A and 2B is associated with a physical address memory space of the NAND flash memory 14.

As shown in FIGS. 2A and 2B, the NAND flash memory 14 is configured by a file system area 14a, write-once area 14b, and management information area 14c. The file system area 14a includes, for example, a partition table and FAT, and is used to manage the logical address space of the NAND flash memory 14. The management information area 14c is assured on an area independent from the logical address space of the NAND flash memory 14, and stores management information used to manage data of the logical address space and other data. This management information area 14c includes the write-once management pointer 15, which manages an address of a write-once accessible area in the write-once area 14b. This address is, for example, that of a cluster to which data was written most recently.

The write-once area 14b is configured by a plurality of clusters, and a write-once access of user data is allowed. Cluster addresses “0” to “5” . . . are set to be larger as they are separated farther away from the file system area 14a. As described above, the write-once area 14b is managed by the write-once management pointer 15, which holds, for example, a cluster address. However, the present embodiment is not limited to this, and the write-once management pointer 15 may hold a head address in a cluster.

<Write-Once Management Pointer 15>

The control operation of the write-once management pointer 15 executed by the MPU 13b will be described below.

In an initial state, the write-once management pointer 15 holds an address of cluster 0 located at a head position of the write-once area 14b, as shown in FIGS. 2A and 2B.

Assume that the host apparatus 11 is, for example, a digital camera, and writes photo data to the memory card 12. For example, assume that the cluster size of the NAND flash memory 14 is 16 Kbytes, and a photo file has a size of 33 Kbytes. In this case, the number of clusters required to write data is given by:

33 Kbytes/16 Kbytes=2.0625

Hence, the number of required clusters is 3 clusters.

It is common practice for the host apparatus 11 to use addresses in turn in ascending order. For this reason, the host apparatus 11 writes the photo file to clusters 2, 3, and 4. Note that clusters 0 and 1 are reserved by the system at the time of formatting, and record, for example, a root directory.

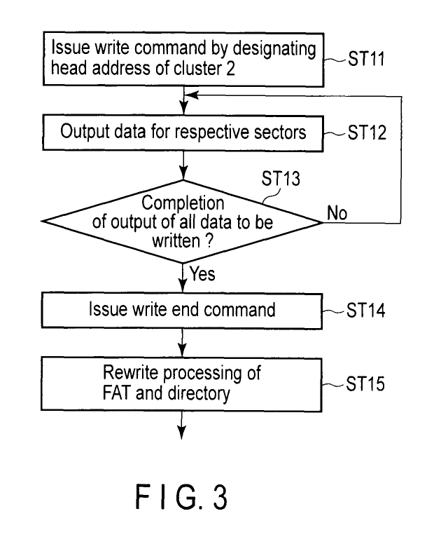

FIG. 3 shows a write operation of the host apparatus 11, for example, a general digital camera.

In the SD card specification, at a write timing, the host apparatus 11 outputs a command set with a start address. That is, in this case, the host apparatus 11 issues a write command by designating a head address of cluster 2 (ST11).

When the photo file has a size of 33 Kbytes and one sector has a size of 512 bytes, the number of sectors is 66, as given by:

33792 bytes/512 bytes=66

After the host apparatus 11 issues the write command by designating the head address of cluster 2, it sequentially outputs data of 66 sectors to the memory card 12 (ST12).

After all data to be written are transferred from the host apparatus 11 to the memory card 12 (ST13), the host apparatus 11 issues a write end command (ST14).

After that, the host apparatus 11 rewrites the contents of the FAT and directory, and registers them in the file system area 14a of the NAND flash memory 14 (ST15).

With the above operation, the photo file of 33 Kbytes is recorded on the memory card 12, and the recorded photo file can be read from the host apparatus 11.

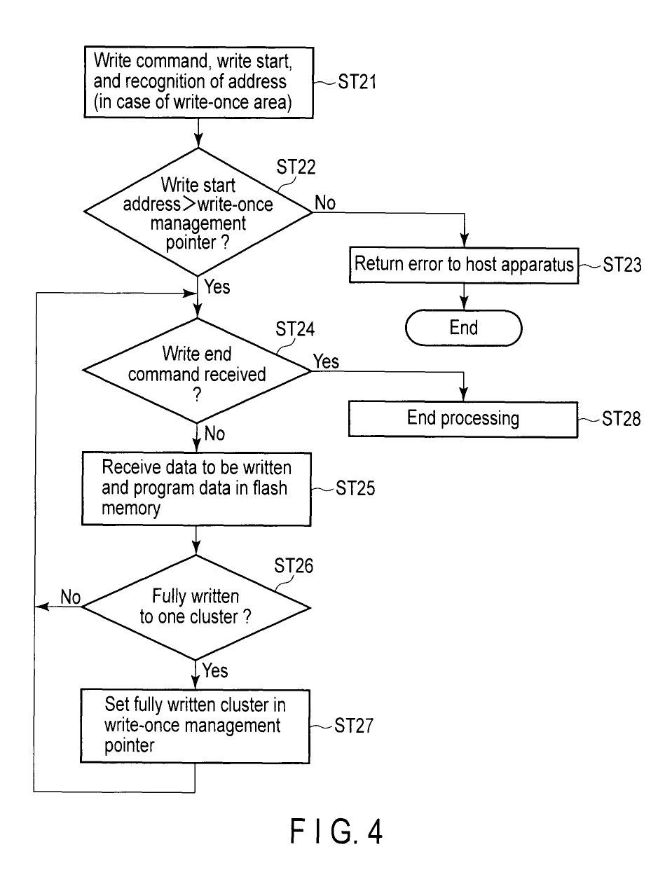

FIG. 4 shows the operation of the card controller 13 executed when the data is written.

When the write command is sent from the host apparatus 11, the card controller 13 recognizes the write command including a write start address (ST21). After that, the card controller 13 determines whether or not the write start address is larger than an address held in the write-once management pointer 15 (ST22). In an initial state, a cluster address of the write-once management pointer 15 is set to “0”, and the write start (head) address sent from the host apparatus 11 is “2” in the above case. Hence, it is determined that a write-once access is permitted.

Note that when the write start address is smaller than the cluster address recorded in the write-once management pointer 15, since data has to be overwritten on the already written cluster, an error notification is returned to the host apparatus 11, thus ending the processing (ST23).

After that, the card controller 13 checks whether or not a write end command is received from the host apparatus 11 (ST24). If no write end command is received, the card controller 13 receives data for respective sectors sent from the host apparatus 11, and writes them to the NAND flash memory 14 (ST25). That is, data are written to cluster 2 designated by the write start address first.

Then, the card controller 13 checks whether or not data have been fully written to one cluster (ST26). If the cluster still includes a free area, the control returns to step ST24 to repeat the above operations.

If data have been fully written to one cluster, that is, if one cluster does not include any free area, the fully written cluster address is set in the write-once management pointer 15. That is, in this case, cluster address 2 is set in the write-once management pointer 15.

Next, the control returns to step ST24, and the above operations are repeated until the write end command is received.

In the write processing, the card controller 13 sets the write-once management pointer 15 as follows. As described above, the contents of the write-once management pointer 15 are read from, for example, the NAND flash memory 14 into the RAM 13e. The MPU 13b writes data to cluster 2, and when no free area remains in cluster 2, the MPU 13b records cluster 2 (cluster address 2) in the write-once management pointer 15. After that, clusters which have been written before cluster 2 can be prevented from being overwritten.

Furthermore, when data are written to cluster 3, and no free area remains in cluster 3, the MPU 13b records cluster address 3 in the write-once management pointer 15. After that, clusters which have been written before cluster 3 can be prevented from being overwritten. Next, data are written to cluster 4.

On the other hand, after data are written to cluster 4, if it is determined in step ST24 that the write end command is received, the card controller 13 executes end processing (ST28). In the end processing, the contents of the write-once management pointer 15 recorded in the RAM 13e are saved in the write-once management pointer 15 in the management area 14c of the NAND flash memory 14. In addition, the card controller 13 executes processing for preparing for a power-off operation of the memory card 12.

As described above, by managing the write-once management pointer 15 for respective clusters, the write-once management processing can be simplified.

When the data write operation is complete in the memory card 12, the host apparatus 11 updates the contents of the FAT and directory, as described above.

In the FAT file system, for example, the clusters which include the data of the photo file in this example have to be registered in the directory and FAT on the file system, thereby updating FAT entries.

The write-once management pointer 15 manages only the write-once area, and is allocated within the management information area 14c. For this reason, the write-once management pointer 15 is not related to the FAT write processing. Therefore, in this embodiment, a description of practical operations about the write processing of the FAT and directory will not be given, and only a change in data of the FAT will be explained.

When data are written to clusters 2, 3, and 4 and are to be recognized as one file, chains of the clusters have to be registered in the FAT.

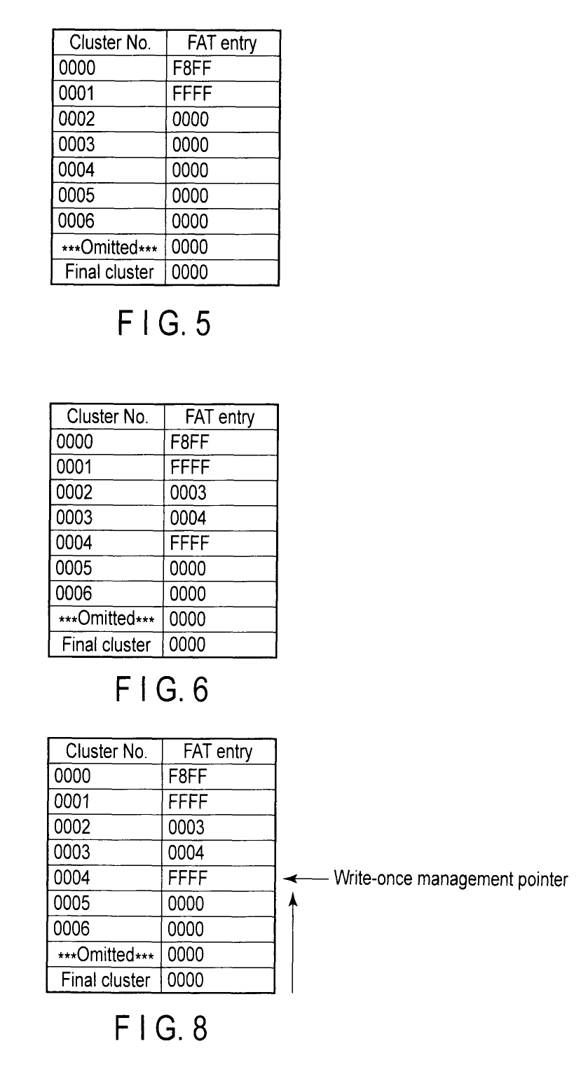

FIG. 5 shows the FAT before a file is written, and FIG. 6 shows the FAT after the file is written. Note that in FIGS. 5 and 6, each cluster address is indicated “cluster No”.

As shown in FIG. 5, before the file is written, FAT entries corresponding to cluster Nos. 2, 3, and 4 store “0000” indicating that each cluster is in an unused state (this expression is used in case of FAT16). Also, the FAT entry value is expressed by a hexadecimal numeral.

When a cluster is assigned to a file, the FAT entry value is changed from “0000” to another value.

That is, as shown in FIG. 6, after the file is written to cluster Nos. 2, 3, and 4, the FAT entry value corresponding to cluster No. 2 is set to “0003”, that corresponding to cluster No. 3 is set to “0004”, and that corresponding to cluster No. 4 is set to “FFFF”. In this case, “FFFF” means an end cluster of the file.

In this way, by updating the contents of the FAT, it can be expressed that one file is configured by clusters 2, 3, and 4.

Also, the directory (not shown) records a file name, size, and the like, and records that the file starts with cluster 2.

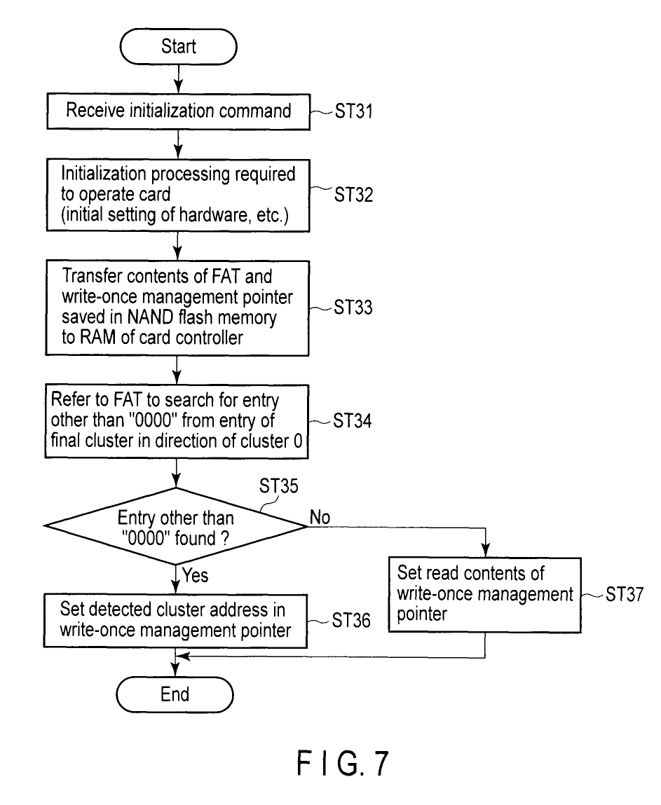

The operations at the time of initialization of the memory card 12 by the MPU 13b will be described below with reference to FIGS. 7 and 8.

When the memory card 12 is connected to the host apparatus 11, the host apparatus 11 issues an initialization command. The card controller 13 receives the initialization command sent from the host apparatus 11 (ST31). In response to this initialization command, initialization processing such as initial settings of hardware required to operate the memory card 12 is executed (ST32).

Then, the contents of the FAT and write-once management pointer 15 are read from the NAND flash memory 14, and are transferred to the RAM 13e of the card controller 13 (ST33).

After that, the MPU 13b refers to the FAT in the RAM 13e to search for a boundary between a cluster to be protected, and that which allows a write-once access after the initialization operation. That is, the MPU 13b searches the FAT in turn from a final cluster in the direction of cluster No. 0 for an entry having a value other than “0000”, as shown in FIG. 8 (ST34, ST35).

As a result of this search, if an entry having a value other than “0000”, for example, an entry having a value “FFFF” is detected, the MPU 13b sets the detected cluster address in the write-once management pointer 15 (ST36). That is, in an example shown in FIG. 8, cluster No. 4 (cluster address 4) corresponding to the entry having the value “FFFF” is recorded in the write-once management pointer 15, thus ending the initialization processing.

In this manner, the initialization processing ends in a state in which the address of the cluster in which data was written latest is recorded in the write-once management pointer 15.

On the other hand, if an entry having a value other than “0000” is not detected in the above search operation, the contents of the write-once management pointer 15 read into the RAM 13e are written to the write-once management pointer 15 again (ST37), thus ending the initialization processing.

When the initialization processing ends, as descried above, the aforementioned write operation is executed using the write-once management pointer 15 in subsequent write processing.

<Operation after Formatting>

Processing executed when the user erroneously executes formatting will be described below.

When formatting is executed, a write access is made to a final cluster by some format programs (formatters). In response to this write operation, the final cluster address is recorded in the write-once management pointer 15. Therefore, at this time, write processing can no longer be executed on the write-once area, and all write commands to the write-once area are not executed as errors.

However, the formatter does not create any file on the memory card and sets the file system in an initial state. For this reason, even when the formatter makes a write access to the final cluster of the memory, it does not set the final cluster in a used state on the FAT. Therefore, since the contents of the FAT are not updated, when the power supply of the memory card is turned on again to execute the initialization operation, the write-once management pointer 15 can be reset to a cluster address to be protected.

That is, in case of this embodiment, after formatting is executed, when the power supply of the memory card 12 is turned off and it is turned on again, the initialization operation shown in FIG. 7 is executed. In this initialization operation, when the host issues an initialization command, the memory card 12 executes the operations in steps ST31, ST32, and ST33, and the FAT is read from the NAND flash memory 14 into the RAM 13e.

After that, the MPU 13b refers to the FAT and searches for an entry having a value other than “0000” (ST34, ST35). Even when formatting is executed, the value “0000” of an entry corresponding to the final cluster remains unchanged on the FAT. For this reason, by executing the search operation, an entry having a value other than “0000” is detected, and an address of the last cluster to which data was written before formatting is reset in the write-once management pointer 15 (ST36). That is, in the example shown in FIG. 8, an entry having a value other than “0000” is searched for in turn from the final cluster, and an entry having a value “FFFF” is detected. Then, cluster address 4 corresponding to this entry is reset in the write-once management pointer 15. Therefore, a write-once access is allowed from cluster address 5.

According to this embodiment, an entry having a value other than “0000” is searched for in turn from the final cluster of the FAT in response to the initialization command. When an entry having a value other than “0000” is detected, a cluster address corresponding to this entry is set in the write-once management pointer 15. For this reason, even when a format operation is executed because of an operation error by the user, by turning on the power supply again to execute the initialization operation, the address of the last cluster to which data was written before formatting can be detected, thus allowing a write-once access. Therefore, the write operation on the card can be prevented from being disabled by the format operation because of an operation error by the user.

Note that in the above embodiment, the write-once management pointer 15 is reset by the initialization operation in response to the initialization command. However, the present embodiment is not limited to this. For example, in another configuration, before a write command is issued, the FAT may be searched for an entry having a value other than “0000” to reset the write-once management pointer 15.

With this configuration, the same effects as in the above embodiment can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile semiconductor storage device having a file system area including a file allocation table (FAT), a data write-once area including a plurality of clusters, and a management information area which stores a pointer indicating a rewrite inhibition area of the clusters; and
a controller configured to read the FAT from the file system area of the nonvolatile semiconductor storage device and to set the pointer based on a cluster use status recorded in the FAT.

2. The system according to claim 1, wherein the controller reads the FAT from the file system area of the nonvolatile semiconductor storage device, and sets the pointer based on the cluster use status recorded in the FAT in an initialization operation of the memory system.

3. The system according to claim 2, wherein when the controller confirms the cluster use status recorded in the FAT, the controller sequentially conducts a search from a cluster having an upper address toward a cluster having a lower address on the FAT, and when a cluster to which data is written is detected, the controller sets an address of the detected cluster in the pointer to set an area from a cluster having a lowermost address to the detected cluster of the data write-once area to be an overwrite inhibition area.

4. The system according to claim 3, wherein when the controller writes data until one cluster of the plurality of clusters is full of data, the controller records an address of the cluster to which the data is written in the pointer.

5. The system according to claim 1, wherein when a power supply of the memory system is turned on, the FAT is read from the file system area of the nonvolatile semiconductor storage device, and the pointer is set based on the cluster use status recorded in the FAT.

6. A method of controlling a memory system comprising:
reading a file allocation table (FAT) from a file system area of a nonvolatile semiconductor storage device, the nonvolatile semiconductor storage device having the file system area including the FAT, a data write-once area including a plurality of clusters, and a management information area which stores a pointer indicating a rewrite inhibition area of the clusters; and
setting the pointer indicating the rewrite inhibition area of the clusters based on a cluster use status recorded in the read FAT.

7. The method according to claim 6, wherein the pointer is set in an initialization operation of the system.

8. The method according to claim 7, wherein the initialization operation sequentially conducts a search from a cluster having an upper address toward a cluster having a lower address on the FAT, and when a cluster to which data is written is detected, the initialization operation sets an address of the detected cluster in the pointer and sets an area from a cluster having a lowermost address to the detected cluster in the data write-once area as an overwrite inhibition area.

9. The method according to claim 8, wherein when data is written until one cluster of the plurality of clusters is full of data, an address of the cluster to which the data is written is recorded in the pointer.

10. The method according to claim 6, wherein when a power supply of the memory system is turned on, the FAT is read from the file system area of the nonvolatile semiconductor storage device, and the pointer is set based on the cluster use status recorded in the FAT.
